(19) United States
(12) Patent Application Publication
(10) Pub. No.: US 2025/0240273 A1
(43) Pub. Date: Jul. 24, 2025

(54) System And Method For Remotely Filtering Network Traffic Of A Customer Premise Device

(71) Applicant: Charter Communications Operating, LLC, St. Louis, MO (US)

(72) Inventor: Richard COMPTON, Highlands Ranch, CO (US)

(21) Appl. No.: 18/418,801

(22) Filed: Jan. 22, 2024

(51) Int. Cl. H04L 9/40

(52) U.S. Cl. CPC H04L 63/0263; H04L 63/0236; H04L 63/1458

(57) ABSTRACT

Systems, methods, and devices for automatically generating, propagating, and applying digitally signed traffic policies to reduce the “surface area” that is vulnerable to cyber-attacks (e.g., volumetric distributed denial of service (DDoS) attacks, etc.), enhance network security and efficiency, and/or mitigate the impact of cyber-attacks. A network device may allow services running on network hosts to autonomously generate, sign, and propagate policies to the network edge. Network routers at the edge may use the digitally signed policies for dynamic filter creation and installation. These filters may restrict network traffic to only specified services and block all network traffic for non-specified services at the network's edge.

### BACKGROUND

Distributed Denial of Service (DDoS) attacks present persistent security challenges for data centers and network hosts. DDoS attacks aim to overwhelm a target with excessive traffic, rendering the service unavailable to legitimate users. Volumetric DDoS attacks are a subset of DDoS attacks that are characterized by the overwhelming volume of traffic directed at a target, consuming bandwidth and resources to the point where the target's network infrastructure is saturated. Volumetric DDoS attacks constitute a considerable threat as they may consume all available bandwidth and incapacitate network resources. Conventional security measures such as firewalls and intrusion detection systems offer inadequate protection against volumetric DDoS attacks.

### SUMMARY

Various aspects include methods of controlling network traffic to reduce cyber-attacks, which may include determining, by a processor in a host computing device, one or more services that are to be exposed to the public internet, generating, by the processor, a traffic policy information element (IE) that may include information identifying the determined services and ports associated with the determined services, digitally signing the generated traffic policy IE, and sending the digitally signed traffic policy IE to a default gateway.

In some aspects, generating the traffic policy IE may include generating the traffic policy IE to include rules or parameters that direct the flow of network traffic, manage network resource access, prioritize specific traffic types, or safeguard against unauthorized or malicious activity. In some aspects, digitally signing the generated traffic policy IE may include generating a digital signature by digitally signing the generated traffic policy IE using a private key of the host computing device. In some aspects, sending the digitally signed traffic policy IE to the default gateway further may include the default gateway propagating the digitally signed policy within the network for enforcement by network routers or switches.

In some aspects, enforcement of the digitally signed policy by network routers or switches reduces volumetric distributed denial of service (DDoS) cyber-attacks in the network. In some aspects, sending the digitally signed traffic policy IE to the default gateway may include sending out the digitally signed traffic policy IE to the default gateway without the host computing device possessing knowledge of the network architecture for receiving protection against the cyber-attacks, and sending the digitally signed traffic policy IE to the default gateway causes one or more network devices to automatically configure and enforce protective measures based on the digitally signed traffic policy IE to simplify endpoint security management and enhance network defenses.

Some aspects may further include methods of controlling network traffic to reduce cyber-attacks, which may include receiving, by a processor in a router deployed at a network edge, a digitally signed traffic policy from a host computing device, determining whether a digital signature of the received digitally signed traffic policy may be valid, determining filter rules based on policy information included in the received digitally signed traffic policy and generating a dynamic filter based on the determined filter rules in response to determining that the digital signature of the received digitally signed traffic policy may be valid, and applying the dynamic filter to one or more designated router interfaces to drop all network traffic to the host computing device for services that are not specified in the received digitally signed traffic policy.

In some aspects, applying the dynamic filter to one or more designated router interfaces to drop all network traffic to the host computing device for services that are not specified in the received digitally signed traffic policy may include applying a dynamic filter that may include specifications based on IP addresses, port numbers, and protocols to permit traffic for specific services while denying all others. Some aspects may further include monitoring for updates to the digitally signed traffic policy, and adjusting the dynamic filter based on detected updates to maintain up-to-date network security measures.

Further aspects may include a computing device having at least one processor configured with processor-executable instructions to perform various operations corresponding to the methods discussed above.

Further aspects may include a non-transitory processor-readable storage medium having stored thereon processor-executable instructions configured to cause at least one processor in a computing device to perform various operations corresponding to the method operations discussed above.

### BRIEF DESCRIPTION OF THE DRAWINGS

The accompanying drawings, which are incorporated herein and constitute part of this specification, illustrate exemplary embodiments, and together with the general description given above and the detailed description given below, serve to explain the features of various embodiments.

FIGS. 1A-1C are system block diagrams that illustrate simplified examples of networks that could be used to implement the various embodiments.

FIG. 2 is a process flow diagram illustrating a method for determining whether to filter network traffic in accordance with the various embodiments.

FIGS. 3A and 3B are process flow diagrams illustrating methods for automatically generating, propagating, and applying digitally signed traffic policies to mitigate volumetric DDoS attacks in accordance with some embodiments.

FIG. 4 is a component diagram of an example server suitable for implementing the various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The term “service provider network” is used generically herein to refer to any network suitable for providing consumers with access to the Internet or IP services over broadband connections and may encompass both wired and wireless networks/technologies. Examples of wired network technologies and networks that may be included within a service provider network include active Ethernet networks, asymmetric digital subscriber line (ADSL) technologies, cable networks, data over cable service interface specification (DOCSIS) networks, enhanced ADSL (ADSL2+), Ethernet, fiber optic networks, fiber-to-the-x (FTTx) technologies, hybrid-fiber-cable (HFC) networks, local area networks (LAN), metropolitan area networks (MAN), passive optical networks (PON), satellite networks, wide area networks (WAN), 10 Gigabit Symmetrical Passive Optical Network (XGS-PON), etc. Examples of wireless network technologies and networks that may be included within a service provider network include third generation wireless mobile communication technology (3G), third generation partnership project (3GPP), 3GSM, fourth generation wireless mobile communication technology (4G), fifth generation wireless mobile communication technology (5G), sixth-generation wireless (6G), advanced mobile phone system (AMPS), Bluetooth®, CDMA systems (e.g., cdmaOne, CDMA2000), digital enhanced cordless telecommunications (DECT), digital AMPS (IS-136/TDMA), enhanced data rates for GSM evolution (EDGE), evolution-data optimized (EV-DO), general packet radio service (GPRS), global system for mobile communications (GSM), high-speed downlink packet access (HSDPA), integrated digital enhanced network (iDEN), land mobile radio (LMR), long term evolution (LTE) systems, low earth orbit (LEO) satellite internet technologies, massive multiple input multiple output (MIMO), millimeter-wave (mmWave) technologies for higher-speed wireless communication, new radio (NR), next-generation wireless systems (NGWS), universal mobile telecommunications system (UMTS), Wi-Fi 7 (802.11be), Wi-Fi Protected Access I & II (WPA, WPA2), wireless local area network (WLAN), worldwide interoperability for microwave access (WiMAX), etc. Each of these wired and wireless technologies discussed herein includes the transmission and reception of data, as well as the exchange of signaling and content messages. It should be noted that references to specific terminology and technical details of individual communications standards or technologies are provided solely for illustration. These references should not be construed as narrowing the scope of the claims to any particular communication system or technology unless specifically recited in the claim language.

The terms “computing device,” “user device” and “user equipment” (UE) may be used generically and interchangeably herein to refer to a broad range of devices such as, but not limited to, access nodes (AN), bridged residential gateways (BRG), cellular telephones, customer-premises equipment (CPE), digital video recorders (DVRs), home networking adapters, internet access gateways, laptops, modems, network switches, personal digital assistants (PDAs), portable multimedia players, rack-mounted computers, residential gateways (RG), routers, satellite or cable set-top boxes (STBs), smart televisions, smartphones, smartwatches, streaming media devices (for example, devices similar to ROKU™), tablet computers, voice-controlled assistants, wearable fitness and health-tracking devices, and wireless gaming controllers. These devices commonly feature a programmable processor, memory, and circuitry for providing the functionality described herein.

The terms “component,” “system,” and the like may be used herein to refer to a computer-related entity, such as hardware, firmware, a combination of hardware and software, software, or software during its execution. These entities may be configured to carry out specific operations or functionalities. For example, a component may encompass a process operating on a processor, a processor itself, an object, an executable, a thread of execution, a program, or a computing device. As an illustrative example, both an application running on a computing device and the computing device itself could be termed a component. One or more components may be situated within a process and/or thread of execution and/or may be localized on a single processor or core or distributed across multiple processors or cores. In addition, these components may execute from various non-transitory computer-readable media having various instructions and/or data structures stored thereon. Components may communicate by way of local and/or remote processes, function or procedure calls, electronic signals, data packets, memory read/writes, and other known computer, processor, and/or process-related communication methodologies.

The term “system on chip” (SoC) is used herein to refer to a single integrated circuit (IC) chip that contains multiple resources or independent processors integrated on a single substrate. A single SoC may contain circuitry for digital, analog, mixed-signal, and radio-frequency functions. A single SoC may include a processing system that includes any number of general-purpose or specialized processors (e.g., network processors, digital signal processors, modem processors, video processors, etc.), memory blocks (e.g., ROM, RAM, Flash, etc.), and resources (e.g., timers, voltage regulators, oscillators, etc.). For example, an SoC may include an applications processor that operates as the SoC's main processor, central processing unit (CPU), microprocessor unit (MPU), arithmetic logic unit (ALU), etc. An SoC processing system also may include software for controlling integrated resources and processors, as well as for controlling peripheral devices.

The term “processing system” is used herein to refer to one or more processors, including multi-core processors, that are organized and configured to perform various computing functions. Various embodiment methods may be implemented in one or more of multiple processors within a processing system as described herein. As such, a computing device tasked with enacting the functionalities described herein may include a processing system with one or multiple processors. The computing device may be a standalone entity or a component of a system-on-chip (SoC). A SoC typically integrates multiple resources, which may encompass specialized processors such as a network, digital signal, or video processor. These specialized processors might be accompanied by memory blocks and other resources for efficient operation. The SoC may include software for controlling these integrated resources, as well as for managing peripheral devices.

The various embodiments include network components configured to automatically generate, propagate, and apply digitally signed traffic policies to reduce the “surface area” that is vulnerable to volumetric distributed denial of service (DDoS) attacks, enhance network security and efficiency, and/or mitigate the impact of volumetric DDoS attacks. The embodiments may allow services running on network hosts to autonomously generate, sign, and propagate policies to the network edge. The network routers at the edge may use the digitally signed policies for dynamic filter creation and installation. These filters may restrict network traffic to only specified services and block all network traffic for non-specified services at the network's edge. As such, the embodiments may protect the host and the broader data center network by blocking attacks that target non-specified services at the network edge.

In some embodiments, the network components (e.g., web server hosts, etc.) may be configured to generate a traffic policy that outlines the services offered to the public internet, such as HTTPS on TCP port 443 and ICMP Echo Request. The network components may digitally sign the traffic policy to help ensure its authenticity and integrity and allow the network edge to recognize and trust the policy. The network components may propagate the signed policy through the network until it reaches the router interfaces that are designated for policy application, such as external border gateway protocol (eBGP) peering interfaces. The network components (e.g., peering router, etc.) may receive and install the signed policy as a dynamic filter that only allows traffic for the services specified in the policy and blocks all other traffic at the network edge.

In some embodiments, the network components may be configured to use certificate authorities and/or cryptographic techniques to validate messages received from hosts, to ensure that only legitimate traffic policies from authenticated sources are accepted, and/or to prevent spoofing attempts by attackers to open unauthorized ports or services.

Unlike other solutions, the various embodiments use digital signatures for network-level DDoS mitigation, install dynamic filters at the edge of the network, distribute and enforce policies at the edge via the dynamic filters, and dynamically adjust security parameters in real time in response to changing conditions. The various embodiments may mitigate the need for manual configuration of network filters, which may in turn reduce administrative overhead and human errors. In addition, the embodiments may automatically update and propagate policies as services on the host change to ensure that network security posture is always current. The embodiments may filter unwanted traffic at the network edge to conserve network bandwidth and resources and/or otherwise improve the overall performance of the network and its components. The embodiments may automate and decentralize the policy generation process to allow the system to scale more effectively with network growth. For these and other reasons, the various embodiments improve the performance and functioning of a communication network and its constituent components.

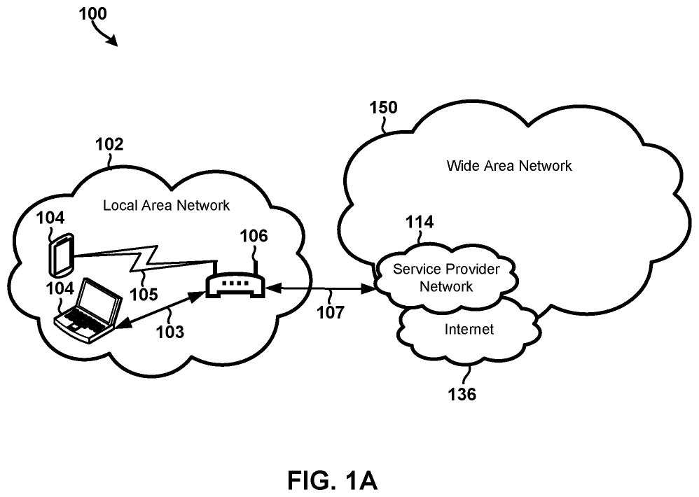

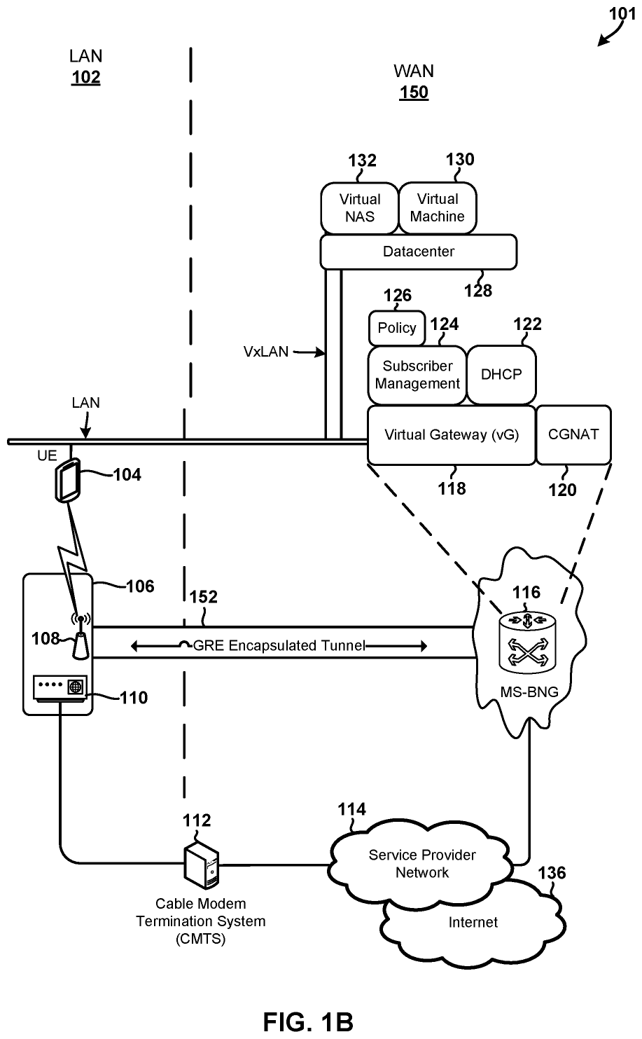

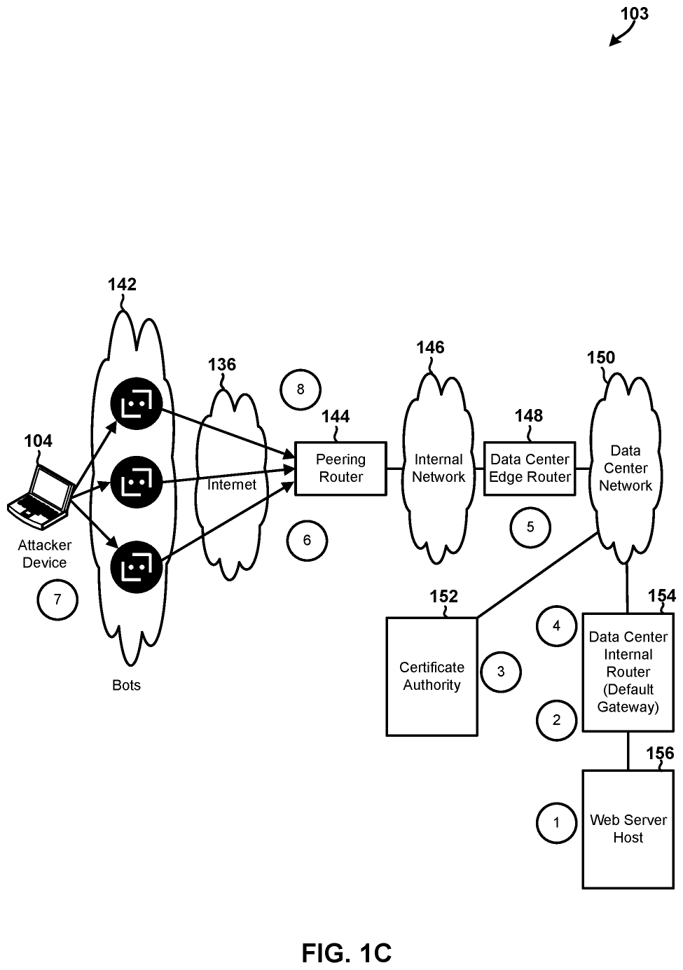

FIGS. 1A-1C are system block diagrams that illustrate simplified examples of networks 100, 101, 103 that may be used to implement the various embodiments. In the example illustrated in FIG. 1A, the network 100 includes a local area network (LAN) 102 and a wide area network (WAN) 150. The LAN 102 includes user equipment (UE) 104 devices coupled to a customer premise equipment (CPE) 106 component/device via wired 103 and wireless 105 communication links. The CPE 106 includes communication links 107 to a service provider network 114 within the WAN 150 that allow the UE 104 devices to send and receive information to and from the Internet 136.

In the example, illustrated in FIG. 1B, the network includes a LAN 102, a UE 104 device, a CPE 106, a bridged residential gateway (BRG) 108, a cable modem (CM) 110, a digital subscriber line access multiplexer (DSLAM) or a cable modem termination system (CMTS) 112, a service provider network 114, a multi-service broadband network gateway (MS-BNG) 116 component, a virtual gateway (vG) 118 component, a carrier-grade network address translation (CGNAT) 120 component, a dynamic host configuration protocol (DHCP) 122 component, a subscriber management 124 component, a policy 126 component, a datacenter 128 component, a virtual machine 130 component, and a virtual network-attached storage (NAS) 132 component. Communications may be facilitated via a generic routing encapsulation (GRE) tunnel 152, local area network (LAN) links, Virtual Extensible LAN (VXLAN) links, and other wired or wireless communication links.

In some embodiments, CPE functions (e.g., DHCP, NAT, firewall, etc.) may be distributed between the BRG 108 in LAN 102 and the MS-BNG 116 or vG 118 in the WAN 150. In some embodiments, the MS-BNG 116 component may be configured to facilitate communications with the CPE 106 component via the GRE-encapsulated tunnel 152. In some embodiments, the MS-BNG 116 component and the CPE 106 component may create a logical subscriber link (LSL) between the BRG 108 component and the vG 118 component.

The CM 110 may be a network bridge that provides bi-directional data communication via radio frequency channels on a hybrid fiber-coaxial (HFC) and/or radio frequency over glass (RFoG) infrastructure. The CMTS 112 component may be deployed in a headend or hubsite, and configured to facilitate high-speed communications between the CM 110 and the components within the service provider network 114. The service provider network 114 may include various network components for providing consumers with access to the Internet 136 or IP services over broadband connections.

The UE 104 communications may be carried over the GRE-encapsulated tunnel 152 via an extended LAN. The GRE encapsulated tunnel 152 may depend on the DOCSIS/CMTS path to egress the residence, home network or LAN 102. The CGNAT 120 component may be configured to translate private-to-private IP addresses and private-to-public IP addresses. The CGNAT 120 may translate the private IP address of the UE 104 component into public IP addresses to allow multiple customer networks to share a common public IP address.

The DHCP 122 component may be an independent platform (with the MS-BNG 116 operating as a DHCP relay) or may be hosted by or within the MS-BNG 116. The DHCP 122 component may be configured to dynamically assign an IP address to each UE 104 device as part of a lease assignment. The DHCP 122 component may send the IP address and other network configuration parameters to each UE 104 device via the BRG 108. The UE 104 device may utilize the assigned IP address to connect to the LAN 102 (and ultimately WAN 150) and communicate with other devices (e.g., other UE devices on the LAN 102, network servers on the WAN 150, etc.) for a period identified by the lease (lease period). The UE 104 device may be configured to issue a request to renew or extend its lease assignment halfway through the lease period. In response, the DHCP 122 component may assign the UE 104 device the same or different address IP address as part of a lease renewal or extension.

The subscriber management 124 component may store subscriber information and/or perform various subscription management operations. The policy 126 component may be configured to determine and/or enforce various rules and policy decisions. The datacenter 128 component, virtual machine 130 component, and virtual NAS 132 component may provide commodity hardware and a secure computing infrastructure for hosting the MS-BNG 116 or vG 118 components. These components may be used for hosting specialized services available to the customer as an extension of their home LAN 102.

The example illustrated in FIG. 1C includes an attacker UE 104 device, bots 142, internet 136, a peering router 144 (edge router), an internal network 146, a data center edge router 148 component, a data center network 150, a certificate authority 152 component, a data center internal router 154 (default gateway), and a web server host 156. The web server host 156 may be configured to determine and identify permissible services and ports, digitally sign a traffic policy, establish a secure connection to the data center internal router 154, and transmit the digitally signed policy. The data center internal router 154 may be configured to receive the digitally signed policy, verify its digital signature, and propagate the policy within the network upon successful verification. Network routers and switches may further propagate the policy and validate the signature before subsequent transmission. The peering router 144 (or another edge router) may be configured to identify the application points for the policy, install dynamic filters according to the received policy, translate the policy into filtering rules, manage the application of the filtering rules, analyze incoming traffic, and enforce conformity to the policy. The peering router 144 may also adjust the filtering rules based on dynamic conditions and synchronize policy updates across the network.

For example, in operation 1, the web server host 156 may initiate the security process by pushing out a digitally signed policy to the data center internal router 154 and identifying services (e.g., HTTPS, ICMP, etc.) provided by the web server host 156. The digitally signed policy may identify specific types of network traffic that are allowed or legitimate for that web server host 156.

In operation 2, the data center internal router 154 may receive the digitally signed policy and communicate with a certificate authority 152 via the data center network 150 to validate the authenticity of the digital signature of the digitally signed policy and/or to otherwise help ensure that the policy originated from a trusted source and has not been modified or altered during transmission.

In operation 3, the certificate authority 152 may perform validation operations to validate the policy for the data center internal router 154. In some embodiments, the validation operations may include verifying the digital signature against known certificates to confirm the policy's integrity and origin.

In operation 4, the data center internal router 154 may determine that the policy is validated and send the digitally signed policy to the data center edge router 148 via the data center network 150.

In operation 5, the data center edge router 148 may receive and propagate the digitally signed policy to the peering router 144, which may include labeled interfaces, including edge interfaces that are connected to peers or transit networks.

In operation 6, the peering router 144 may receive and install the digitally signed policy as firewall rules specifically on the edge interfaces to the peers and/or transit networks. The installation of the policy may allow for enforcing the policy and/or may allow for filtering of traffic according to the defined rules at the network boundary.

In operation 7, an attacker UE 104 device may use the network of bots 142 to launch a DDoS attack that targets the web server host 156 using UDP port 53 and attempts to overwhelm the web server host 156 with a flood of malicious/attack traffic.

In operation 8, the peering router 144 may enforce the firewall rules implemented in operation 6 to effectively drop the malicious/attack traffic from the bots 142 at the peering edge and allow legitimate traffic through to the web server host 156. This selective filtering of traffic may mitigate the DDoS attack and protect the web server host 156 from being overwhelmed by malicious traffic.

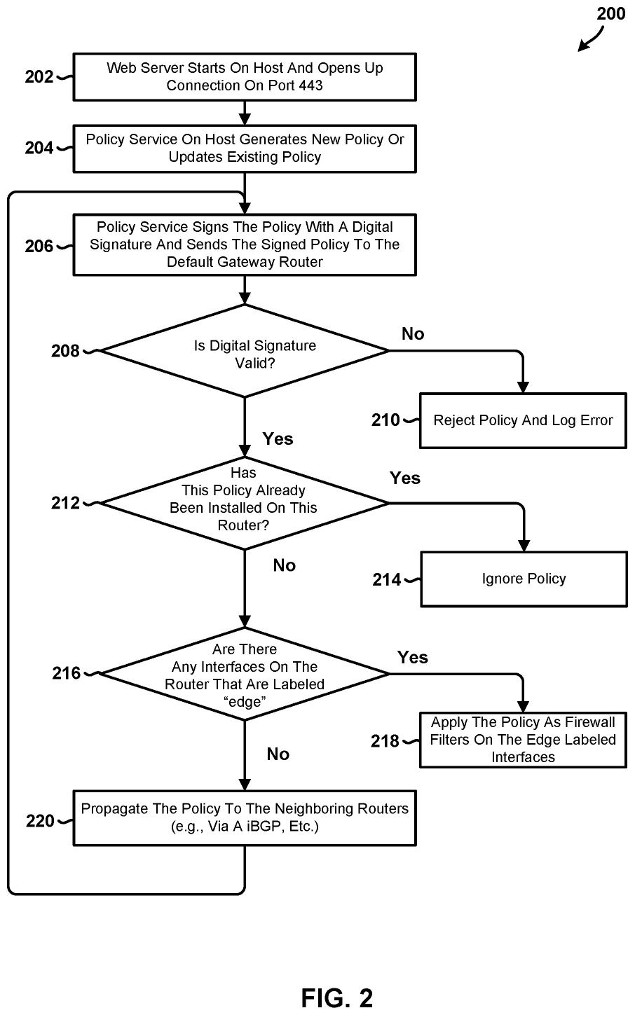

FIG. 2 is a process flow diagram illustrating a method 200 for determining whether to filter network traffic in accordance with the various embodiments. Method 200 may be performed by a processor or processing system of a computing system (e.g., peering router 144, security server computing device, etc.) that is deployed in the network (e.g., the service provider network 114, WAN 150, etc.) to determine whether the firewall rules (or requirements or preconditions for targeted filtering of network traffic) are met.

In block 202, a processor in the web server host 156 may initiate the service by starting the server and opening a connection on port 443 (i.e., the standard port for HTTPS traffic, as opposed to port 80 for unencrypted HTTP traffic). For example, the processor may execute a script that configures the server software to listen on port 443. These operations may allow for secure communications over the internet (e.g., as opposed to sending unencrypted HTTP traffic on port 80, etc.).

In block 204, the policy service on the web server host 156 may generate a new policy or update an existing policy. For example, the processor may run a policy management application that dynamically adjusts network rules based on the services currently offered by the web server host. The processor may generate a policy that accurately reflects the current state of the server's offerings.

In block 206, the policy service may sign the policy with a digital signature and send the signed policy to the default gateway router (e.g., data center internal router 154, etc.). For example, the processor may use cryptographic algorithms to sign the policy and/or signify its authenticity to enhance the integrity and security of the policy transmission (i.e., compared to conventional solutions that transmit the policy without such security measures).

In determination block 208, a processor in the default gateway router 154 may determine the validity of the digital signature. For example, the processor may use the certificate authority, or a public key associated with the web server host, to verify the signature.

In response to determining that the digital signature is not valid (i.e., determination block 208=“No”), the processor may reject the policy and log the error in block 210.

In response to determining that the digital signature is valid (i.e., determination block 208=“Yes”), the processor may determine whether the policy has already been installed in determination block 212. For example, the processor may query an internal database of currently active policies to determine whether the policy is already in place.

In response to determining that the policy has already been installed on the default gateway router (i.e., determination block 208=“Yes”), the processor may ignore the policy in block 214 to avoid redundant application of the same policy.

In response to determining that the policy has not been installed on the default gateway router (i.e., determination block 212=“No”), the processor may determine whether there are any interfaces on the peering router that are labeled “edge” in determination block 216. For example, the processor may query the router's configuration to identify interfaces marked for external traffic management.

In response to determining that there are interfaces on the peering router labeled “edge” (i.e., determination block 216=“Yes”), the processor may apply the policy firewall filters on these interfaces in block 218. In response to determining that there are no interfaces on the peering router labeled “edge” (i.e., determination block 216=“No”), the processor may use protocols such as internal border gateway protocol (iBGP) to propagate the policy to neighboring routers in block 220. For example, the processor may send the policy to adjacent routers in the network for a wider dissemination of the policy and/or to enhance network-wide security. The processors may perform the operations in blocks 206-220 repeatedly.

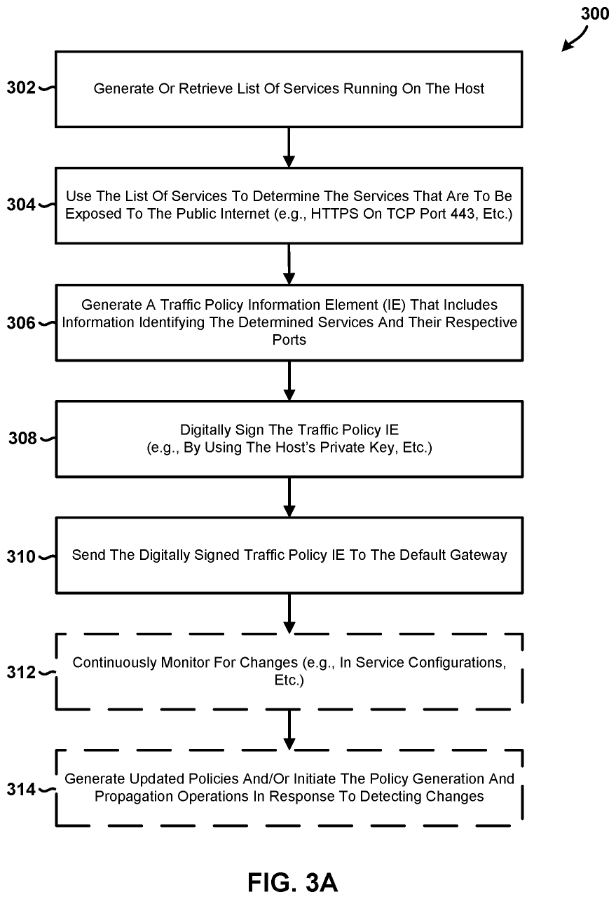

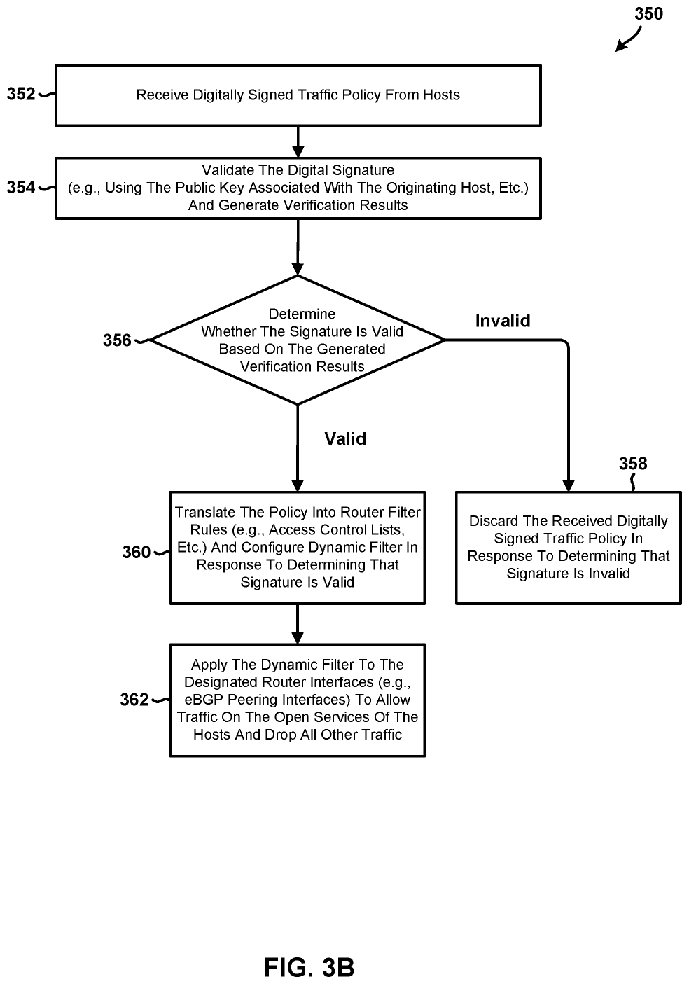

FIGS. 3A and 3B are process flow diagrams illustrating methods 300, 350 for automatically generating, propagating, and applying digitally signed traffic policies to mitigate volumetric DDoS attacks in accordance with some embodiments. Method 300 may be performed by a processor or processing system in a host computing device (e.g., web server host 156, etc.). Method 350 may be performed by a processor or processing system in a network computing device (e.g., peering router 144, etc.).

With reference to FIG. 3A, in block 302 a processor in a host computing device (e.g., web server host 156, etc.) may generate or retrieve a list of services running on the host. For example, the processor may execute a command that scans the operating system for active services and compiles a list that may be used to inventory the services that are potentially available for external access. Examples of such services include web servers (e.g., Apache, etc.) running on HTTP/HTTPS ports (80, 443, etc.), FTP servers for file transfers, SMTP services for email transmission, and database services (e.g., MySQL, etc.). These services are accessible over the network and may require careful management and monitoring to ensure they are exposed only as intended and secured against unauthorized access.

In block 304, the processor may use the list of services to determine the services that are to be exposed to the public Internet (e.g., HTTPS on TCP port 443, etc.) and/or otherwise determine permissible services and ports. For example, the processor may filter the generated/retrieved list based on predefined criteria to identify services that should be publicly accessible and use the filtered list to define the scope of the traffic policy and/or focus on services that need to be managed securely. Examples of such predefined criteria include the security level of the service (e.g., SSL/TLS for secure communication, etc.), the necessity of the service for external users (e.g., a web service that must be accessible for the website to function, etc.), the compliance requirements (e.g., services that must be exposed according to regulatory standards, etc.), and the historical data of network usage (e.g., identifying services that are frequently accessed from external networks, etc.). This selective approach may help ensure that only essential and secure services are exposed and/or may otherwise enhance the overall security of the host while maintaining necessary functionality.

In block 306, the processor may generate a traffic policy information element (IE) that includes information identifying the determined services and their respective ports. For example, the processor may create a structured document (e.g., XML, JSON, etc.) detailing the service names and their corresponding port numbers. The processor may use the traffic policy IE to indicate how the network should handle incoming and outgoing traffic for these services (e.g., allow or block). In some embodiments, the processor may generate the traffic policy IE to include a set of rules or parameters that direct the flow of network traffic, manage network resource access and distribution, prioritize specific traffic types, maintain Quality of Service (QOS), and/or safeguard against unauthorized or malicious activity.

In block 308, the processor may digitally sign the traffic policy IE (e.g., by using the host's private key, etc.). For example, the processor may use a certificate authority and/or cryptographic algorithms to generate a digital signature that uniquely identifies the host. A certificate authority may be an external trusted entity that issues digital certificates certifying the ownership of a public key by the named subject of the certificate. These certificates may be used to verify the credibility and authenticity of the host to others in the network. Examples of cryptographic algorithms include Rivest-Shamir-Adleman (RSA) and Elliptic Curve Digital Signature Algorithm (ECDSA).

In block 310, the processor may send the digitally signed traffic policy IE to the default gateway. For example, the processor may use network protocols to transmit the policy to the designated network router and/or to disseminate the policy across the network so that it reaches all the relevant network components. The digital signature may allow the policy to be authenticated before it is relayed from the default gateway router through the network. Routers at the network boundaries (e.g., the juncture between a private local network and the public internet, etc.) may receive these authenticated policies and translate them into dynamic packet filters that define permissible services and their communication ports. The dynamic packet filters may be applied at the network periphery to limit traffic to only the services outlined by the host.

In block 312, the processor may continuously monitor for changes (e.g., in service configurations, etc.). For example, the processor may regularly check the system for any alterations in the services or their settings. Examples of such changes or alterations include the addition of new services or the removal of existing ones, updates to the software that may introduce new features or change the way current services operate, modifications in the network ports that services use for communication, changes in the configuration settings that might alter the access permissions or security protocols of the services, and adjustments in the service dependencies that could affect the overall network infrastructure. Monitoring these conditions may be important for maintaining an up-to-date and secure network environment. In addition, monitoring these conditions allows the system to adapt to changes and ensure that the security policies are always aligned with the current state of the services provided by the host.

In block 314, the processor may generate updated policies and/or initiate the policy generation and propagation operations in response to detecting changes. For example, in instances in which a new service is added or an existing one is modified, the processor may regenerate the traffic policy IE to reflect these changes and ensure that the network security policies remain relevant and effective.

With reference to FIG. 3B, in block 352 a processor in a network computing device (e.g., peering router 144, etc.) may receive digitally signed traffic policy from hosts. For example, the processor may capture and store incoming policy data packets from the network that may be used to understand and enforce the traffic rules dictated by the hosts. The digitally signed traffic policy may be a comprehensive set of rules and guidelines that define which types of network traffic should be allowed or denied, including specific services and their corresponding ports. These policies may be encoded in a format that the router may interpret and apply to its filtering mechanisms. The digital signature attached to these policies may serve as a verification tool and/or to confirm that the policy originates from a trusted source and has not been altered in transit.

In block 354, the processor may validate the digital signature (e.g., using the public key associated with the originating host, etc.) and generate verification results. For example, the processor may use a certificate authority and/or cryptographic verification methods to verify the integrity and authenticity of the received policies. Examples of such cryptographic verification methods include Public Key Infrastructure (PKI), which relies on a combination of public and private keys to verify the identity of the sender and the integrity of the message, and hash functions that create a unique digital fingerprint of the data. In some embodiments, the processor may use asymmetric cryptography algorithms, such as RSA or ECDSA, which allow the use of a public key for verifying a signature made with a corresponding private key. These operations and techniques provide a robust framework for ensuring that the policy has not been tampered with and originates from a legitimate source.

In determination block 356, the processor may determine whether the signature is valid based on the generated verification results. For example, the processor may compare the signature against the known public key. The processor may determine that the signature is valid in response to determining that the signature matches the known public key. The processor may determine that the policy should be trusted and applied in response to determining that the signature is valid.

In block 358, the processor may discard the received digitally signed traffic policy in response to determining that the signature is invalid. That is, the processor may discard or delete the policy from memory and log an error if the verification fails, which may help maintain network security and prevent potential breaches.

In block 360, the processor may translate the policy into router filter rules and configure a dynamic filter in response to determining that the signature is valid. For example, the processor may parse the digitally signed traffic policy and convert its rules and directives into actionable router configurations (filters) that control network traffic according to the host-defined rules. A filter may be a set of criteria or conditions applied to network traffic to determine whether it should be allowed or blocked. Examples of router filter rules include specifications based on IP addresses, port numbers, protocols (e.g., TCP, UDP, etc.), and packet content types. These rules may be used to permit traffic for specific services while denying all others. Examples of actionable router configurations include setting up Access Control Lists (ACLs) that explicitly allow or deny traffic based on the aforementioned criteria, configuring QoS settings to prioritize certain types of traffic, and implementing security policies that block potentially harmful traffic, such as packets from known malicious sources. These configurations may allow the router to actively manage the flow of data through the network to adhere to established security protocols and for the efficient functioning of the network services.

In block 362, the processor may apply the dynamic filter to the designated router interfaces (e.g., eBGP peering interfaces) to allow traffic on the open services of the hosts and drop all other traffic. For example, the processor may activate the new filtering rules on specific interfaces that handle external traffic. Applying the dynamic filter may operationalize the policy to allow traffic for the open services of the hosts while blocking all other traffic. A router interface may be a physical or virtual point of connection where the router communicates with other network devices or networks. This interface may be responsible for receiving and transmitting data packets and applying various network policies, including security rules and traffic management directives. Examples of router interfaces include Ethernet ports, which are common in local area networks (LANs); Serial ports, often used in wide area networks (WANs) for long-distance communication; and virtual interfaces (e.g., tunnel interfaces) that facilitate VPN connections. The eBGP peering interface may be used to manage the flow of traffic between different autonomous systems in the internet, inter-network communications, and policy enforcement.

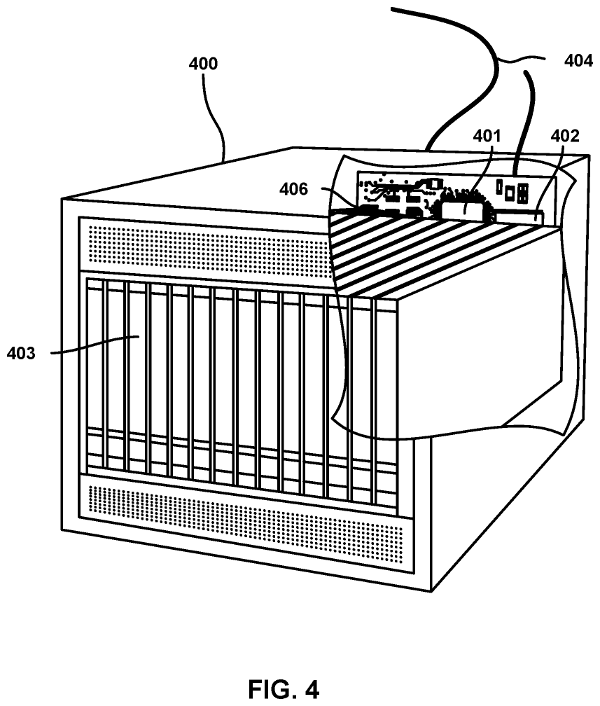

Various embodiments (including, but not limited to, embodiments discussed above with reference to FIGS. 1A-3B) may be implemented on any of a variety of commercially available computing devices, such as the server computing device 600 illustrated in FIG. 4. Such a server device 400 may include a processor 401 coupled to volatile memory 402 and a large capacity nonvolatile memory, such as a disk drive 403. The server device 400 may also include a floppy disc drive, USB, compact disc (CD) or DVD disc drive coupled to the processor 401. The server device 400 may also include network access ports 406 coupled to the processor 401 for establishing data connections with a network connection circuit 404 and a communication network (e.g., IP network) coupled to other communication system network elements.

The processors discussed in this application may be any programmable microprocessor, microcomputer or multiple processor chip or chips that can be configured by software instructions (applications) to perform a variety of functions, including the functions of the various embodiments described above. In some devices, multiple processors may be provided, such as one processor dedicated to wireless communication functions and one processor dedicated to running other applications. Typically, software applications may be stored in the internal memory before they are accessed and loaded into the processors. The processors may include internal memory sufficient to store the application software instructions. In many devices, the internal memory may be a volatile or nonvolatile memory, such as flash memory, or a mixture of both. For the purposes of this description, a general reference to memory refers to memory accessible by the processors including internal memory or removable memory plugged into the device and memory within the processors themselves. Additionally, as used herein, any reference to a memory may be a reference to a memory storage and the terms may be used interchangeable.

Implementation examples are described in the following paragraphs. While some of the following implementation examples are described in terms of example methods, further example implementations may include: the example methods discussed in the following paragraphs implemented by a network apparatus including processing system coupled to memory and configured (e.g., with processor-executable instructions) to perform operations of the methods of the following implementation examples; the example methods discussed in the following paragraphs implemented by a network apparatus including means for performing functions of the methods of the following implementation examples; and the example methods discussed in the following paragraphs may be implemented as a non-transitory processor-readable storage medium having stored thereon processor-executable instructions configured to cause a processor of a network apparatus to perform the operations of the methods of the following implementation examples.

Example 1: A method of controlling network traffic to reduce cyber-attacks, including determining, by a processor in a host computing device, one or more services that are to be exposed to the public internet, generating, by the processor, a traffic policy information element (IE) that includes information identifying the determined services and ports associated with the determined services, digitally signing the generated traffic policy IE, and sending the digitally signed traffic policy IE to a default gateway.

Example 2: The method of example 1, further including monitoring for changes in service configurations and updating the traffic policy IE based on a current state of services provided by the host.

Example 3: The method of any of the examples 1 and 2, in which generating the traffic policy IE includes generating the traffic policy IE to include rules or parameters that direct the flow of network traffic, manage network resource access, prioritize specific traffic types, or safeguard against unauthorized or malicious activity.

Example 4: The method of any of the examples 1-3, in which digitally signing the generated traffic policy IE includes generating a digital signature by digitally signing the generated traffic policy IE using a private key of the host computing device.

Example 5: The method of example 4, further including verifying the digital signature against a known certificate or public key to confirm an origin of the traffic policy IE.

Example 6: The method of any of the examples 1-5, in which sending the digitally signed traffic policy IE to the default gateway further includes the default gateway propagating the digitally signed policy within the network for enforcement by network routers or switches.

Example 7: The method of any of the examples 1-6, in which enforcement of the digitally signed policy by network routers or switches reduces volumetric distributed denial of service (DDoS) cyber-attacks in the network.

Example 8: The method of any of the examples 1-7, in which sending the digitally signed traffic policy IE to the default gateway includes sending out the digitally signed traffic policy IE to the default gateway without the host computing device possessing knowledge of the network architecture for receiving protection against the cyber-attacks, and sending the digitally signed traffic policy IE to the default gateway causes one or more network devices to automatically configure and enforce protective measures based on the digitally signed traffic policy IE to simplify endpoint security management and enhance network defenses.

Example 9: A method of controlling network traffic to reduce cyber-attacks, including receiving, by a processor in a router deployed at a network edge, a digitally signed traffic policy from a host computing device, determining whether a digital signature of the received digitally signed traffic policy is valid, determining filter rules based on policy information included in the received digitally signed traffic policy and generating a dynamic filter based on the determined filter rules in response to determining that the digital signature of the received digitally signed traffic policy is valid, and applying the dynamic filter to one or more designated router interfaces to drop all network traffic to the host computing device for services that are not specified in the received digitally signed traffic policy.

Example 10: The method of example 9, further including discarding the received digitally signed traffic policy and logging an error in response to determining that the digital signature is invalid.

Example 11: The method of any of the examples 9 and 10, in which applying the dynamic filter to one or more designated router interfaces to drop all network traffic to the host computing device for services that are not specified in the received digitally signed traffic policy includes applying a dynamic filter that includes specifications based on IP addresses, port numbers, and protocols to permit traffic for specific services while denying all others.

Example 28: The method of any of the examples 9-11, further including monitoring for updates to the digitally signed traffic policy, and adjusting the dynamic filter based on detected updates to maintain up-to-date network security measures.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, components, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary embodiments, the functions described may be implemented in hardware, software, firmware, or any combination thereof. If implemented in software, the functions may be stored as one or more instructions or code on a non-transitory computer-readable medium or non-transitory processor-readable medium. The steps of a method or algorithm disclosed herein may be embodied in a processor-executable software module and/or processor-executable instructions, which may reside on a non-transitory computer-readable or non-transitory processor-readable storage medium. Non-transitory server-readable, computer-readable or processor-readable storage media may be any storage media that may be accessed by a computer or a processor. By way of example but not limitation, such non-transitory server-readable, computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, DVD, floppy disk, and Blu-ray disc where disks usually reproduce data magnetically, while discs reproduce data optically with lasers. Combinations of the above are also included within the scope of non-transitory server-readable, computer-readable and processor-readable media. Additionally, the operations of a method or algorithm may reside as one or any combination or set of codes and/or instructions on a non-transitory server-readable, processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method of controlling network traffic to reduce cyber-attacks, comprising:
determining, by a processor in a host computing device, one or more services that are to be exposed to the public internet;
generating, by the processor, a traffic policy information element (IE) that includes information identifying the determined services and ports associated with the determined services;
digitally signing the generated traffic policy IE; and
sending the digitally signed traffic policy IE to a default gateway.

2. The method of claim 1, further comprising monitoring for changes in service configurations and updating the traffic policy IE based on a current state of services provided by the host.

3. The method of claim 1, wherein generating the traffic policy IE comprises generating the traffic policy IE to include rules or parameters that direct the flow of network traffic, manage network resource access, prioritize specific traffic types, or safeguard against unauthorized or malicious activity.

4. The method of claim 1, wherein digitally signing the generated traffic policy IE comprises generating a digital signature by digitally signing the generated traffic policy IE using a private key of the host computing device.

5. The method of claim 4, further comprising verifying the digital signature against a known certificate or public key to confirm an origin of the traffic policy IE.

6. The method of claim 1, wherein sending the digitally signed traffic policy IE to the default gateway further comprises the default gateway propagating the digitally signed policy within the network for enforcement by network routers or switches.

7. The method of claim 1, wherein enforcement of the digitally signed policy by network routers or switches reduces volumetric distributed denial of service (DDoS) cyber-attacks in the network.

8. The method of claim 1, wherein:
sending the digitally signed traffic policy IE to the default gateway comprises sending out the digitally signed traffic policy IE to the default gateway without the host computing device possessing knowledge of the network architecture for receiving protection against the cyber-attacks; and
sending the digitally signed traffic policy IE to the default gateway causes one or more network devices to automatically configure and enforce protective measures based on the digitally signed traffic policy IE to simplify endpoint security management and enhance network defenses.

9. A computing device, comprising:
at least one processor configured to:
determine one or more services that are to be exposed to the public internet;
generate a traffic policy information element (IE) that includes information identifying the determined services and ports associated with the determined services;
digitally sign the generated traffic policy IE; and
send the digitally signed traffic policy IE to a default gateway.

10. The computing device of claim 9, wherein the at least one processor is further configured to monitor for changes in service configurations and update the traffic policy IE based on a current state of services provided by the host.

11. The computing device of claim 9, wherein the at least one processor is configured to generate the traffic policy IE to include rules or parameters that direct the flow of network traffic, manage network resource access, prioritize specific traffic types, or safeguard against unauthorized or malicious activity.

12. The computing device of claim 9, wherein the at least one processor is configured to digitally sign the generated traffic policy IE by generating a digital signature by digitally signing the generated traffic policy IE using a private key of the host computing device.

13. The computing device of claim 12, wherein the at least one processor is further configured to verify the digital signature against a known certificate or public key to confirm an origin of the traffic policy IE.

14. The computing device of claim 9, wherein the at least one processor is configured to send the digitally signed traffic policy IE to the default gateway to cause the default gateway to propagate the digitally signed policy within the network for enforcement by network routers or switches.

15. The computing device of claim 9, wherein the at least one processor is configured to send the digitally signed traffic policy IE to the default gateway to cause enforcement of the digitally signed policy by network routers or switches reduces volumetric distributed denial of service (DDoS) cyber-attacks in the network.

16. The computing device of claim 9, wherein the at least one processor is configured to:
send the digitally signed traffic policy IE to the default gateway by sending out the digitally signed traffic policy IE to the default gateway without the host computing device possessing knowledge of the network architecture for receiving protection against the cyber-attacks; and
sending the digitally signed traffic policy IE to the default gateway to cause one or more network devices to automatically configure and enforce protective measures based on the digitally signed traffic policy IE to simplify endpoint security management and enhance network defenses.

17. A non-transitory processor-readable medium having stored thereon processor-readable instructions configured to cause at least one processor in a computing device to perform operations for controlling network traffic to reduce cyber-attacks, the operations comprising:
determining one or more services that are to be exposed to the public internet;
generating a traffic policy information element (IE) that includes information identifying the determined services and ports associated with the determined services;
digitally signing the generated traffic policy IE; and
sending the digitally signed traffic policy IE to the default gateway.

18. The non-transitory processor-readable medium of claim 17, wherein the stored processor-readable instructions are configured to cause the at least one processor in the computing device to perform operations further comprising monitoring for changes in service configurations and updating the traffic policy IE based on a current state of services provided by the host.

19. The non-transitory processor-readable medium of claim 17, wherein the stored processor-readable instructions are configured to cause the at least one processor in the computing device to perform operations such that generating the traffic policy IE comprises generating the traffic policy IE to include rules or parameters that direct the flow of network traffic, manage network resource access, prioritize specific traffic types, or safeguard against unauthorized or malicious activity.

20. The non-transitory processor-readable medium of claim 17, wherein the stored processor-readable instructions are configured to cause the at least one processor in the computing device to perform operations such that digitally signing the generated traffic policy IE comprises generating a digital signature by digitally signing the generated traffic policy IE using a private key of the host computing device.

21. The non-transitory processor-readable medium of claim 20, wherein the stored processor-readable instructions are configured to cause the at least one processor in the computing device to perform operations further comprising verifying the digital signature against a known certificate or public key to confirm an origin of the traffic policy IE.

22. The non-transitory processor-readable medium of claim 17, wherein the stored processor-readable instructions are configured to cause the at least one processor in the computing device to perform operations such that sending the digitally signed traffic policy IE to the default gateway further comprises the default gateway propagating the digitally signed policy within the network for enforcement by network routers or switches.

23. The non-transitory processor-readable medium of claim 17, wherein the stored processor-readable instructions are configured to cause the at least one processor in the computing device to perform operations such that enforcement of the digitally signed policy by network routers or switches reduces volumetric distributed denial of service (DDoS) cyber-attacks in the network.

24. The non-transitory processor-readable medium of claim 17, wherein the stored processor-readable instructions are configured to cause the at least one processor in the computing device to perform operations such that:
sending the digitally signed traffic policy IE to the default gateway comprises sending out the digitally signed traffic policy IE to the default gateway without the host computing device possessing knowledge of the network architecture for receiving protection against the cyber-attacks; and
sending the digitally signed traffic policy IE to the default gateway causes one or more network devices to automatically configure and enforce protective measures based on the digitally signed traffic policy IE to simplify endpoint security management and enhance network defenses.

25. A method of controlling network traffic to reduce cyber-attacks, comprising:
receiving, by a processor in a router deployed at a network edge, a digitally signed traffic policy from a host computing device;
determining whether a digital signature of the received digitally signed traffic policy is valid;
determining filter rules based on policy information included in the received digitally signed traffic policy and generating a dynamic filter based on the determined filter rules in response to determining that the digital signature of the received digitally signed traffic policy is valid; and
applying the dynamic filter to one or more designated router interfaces to drop all network traffic to the host computing device for services that are not specified in the received digitally signed traffic policy.

26. The method of claim 25, further comprising discarding the received digitally signed traffic policy and logging an error in response to determining that the digital signature is invalid.

27. The method of claim 25, wherein applying the dynamic filter to one or more designated router interfaces to drop all network traffic to the host computing device for services that are not specified in the received digitally signed traffic policy comprises applying a dynamic filter that includes specifications based on IP addresses, port numbers, and protocols to permit traffic for specific services while denying all others.

28. The method of claim 25, further comprising:
monitoring for updates to the digitally signed traffic policy; and
adjusting the dynamic filter based on detected updates to maintain up-to-date network security measures.

29. A computing device, comprising:
at least one processor configured to:
receive, at a network edge, a digitally signed traffic policy from a host computing device;
determine whether a digital signature of the received digitally signed traffic policy is valid;
determine filter rules based on policy information included in the received digitally signed traffic policy and generating a dynamic filter based on the determined filter rules in response to determining that the digital signature of the received digitally signed traffic policy is valid; and
apply the dynamic filter to one or more designated router interfaces to drop all network traffic to the host computing device for services that are not specified in the received digitally signed traffic policy.

30. The computing device of claim 29, wherein the at least one processor is further configured to discard the received digitally signed traffic policy and logging an error in response to determining that the digital signature is invalid.

31. The computing device of claim 29, wherein the at least one processor is configured to apply the dynamic filter to one or more designated router interfaces to drop all network traffic to the host computing device for services that are not specified in the received digitally signed traffic policy by applying a dynamic filter that includes specifications based on IP addresses, port numbers, and protocols to permit traffic for specific services while denying all others.

32. The computing device of claim 29, wherein the at least one processor is further configured to:
monitor for updates to the digitally signed traffic policy; and
adjust the dynamic filter based on detected updates to maintain up-to-date network security measures.

33. A non-transitory processor-readable medium having stored thereon processor-readable instructions configured to cause at least one processor in a computing device to perform operations for controlling network traffic to reduce cyber-attacks, the operations comprising:
receiving, at a network edge, a digitally signed traffic policy from a host computing device;
determining whether a digital signature of the received digitally signed traffic policy is valid;
determining filter rules based on policy information included in the received digitally signed traffic policy and generating a dynamic filter based on the determined filter rules in response to determining that the digital signature of the received digitally signed traffic policy is valid; and
applying the dynamic filter to one or more designated router interfaces to drop all network traffic to the host computing device for services that are not specified in the received digitally signed traffic policy.

34. The non-transitory processor-readable medium of claim 29, wherein the stored processor-readable instructions are configured to cause the at least one processor in the computing device to perform operations further comprising discarding the received digitally signed traffic policy and logging an error in response to determining that the digital signature is invalid.

35. The non-transitory processor-readable medium of claim 29, wherein the stored processor-readable instructions are configured to cause the at least one processor in the computing device to perform operations such that applying the dynamic filter to one or more designated router interfaces to drop all network traffic to the host computing device for services that are not specified in the received digitally signed traffic policy comprises applying a dynamic filter that includes specifications based on IP addresses, port numbers, and protocols to permit traffic for specific services while denying all others.

36. The non-transitory processor-readable medium of claim 29, wherein the stored processor-readable instructions are configured to cause the at least one processor in the computing device to perform operations further comprising:
monitoring for updates to the digitally signed traffic policy; and
adjusting the dynamic filter based on detected updates to maintain up-to-date network security measures.
